(19) United States
(12) Patent Application Publication
(10) Pub. No.: US 2005/0275883 A1
(43) Pub. Date: Dec. 15, 2005

(54) Information processing apparatus and its control method

(75) Inventors: Noriyuki Kobayashi, Kawasaki-shi (JP); Yushi Matsukubo, Yokohama-shi (JP); Yukihiko Shimizu, Urayasu-shi (JP); Masataka Yasuda, Kawasaki-shi (JP); Shinichiro Maekawa, Kawasaki-shi (JP); Takeshi Namikata, Yokohama-shi (JP); Hideki Sakai, Sakura-shi (JP); Hirohiko Tashiro, Kawasaki-shi (JP); Atsushi Matsumoto, Tokyo (JP); Masamichi Akashi, Funabashi-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/148,269

(22) Filed: Jun. 9, 2005

(30) Foreign Application Priority Data
Jun. 9, 2004 (JP) 2004-171766

(51) Int. Cl. G06F 15/00

(52) U.S. Cl. 358/1.15

(57) ABSTRACT

A mechanism that attains high-speed processing by distributing a great deal of processing to a plurality of devices upon processing does not perform processing distribution which considers hardware resources of devices used in distributed processing. When rendering processing of a print job is executed by distributed processing using devices connected to a computer network, it is determined whether hardware or software rendering processing is executed (S1102, S1103). Image processing devices which can implement hardware or software rendering processing are sought from devices connected to the computer network (S1104, S1106). Based on the determination and seek results, devices to which jobs divided from the print job are transmitted are notified (S1108).

### FIELD OF THE INVENTION

The present invention relates to an information processing apparatus and its control method and, more particularly, to effective use of hardware resources of an information processing apparatus and the like when the distributed load system of grid computing is applied to printers, multi-functional peripheral equipment, and the like connected to a computer network.

### BACKGROUND OF THE INVENTION

Many proposals have been made about a mechanism that attains high-speed processing by distributing a great deal of processing to a plurality of devices upon processing. However, these proposals do not perform processing distribution that considers hardware resources of devices which execute distributed processing. That is, as a target device of distributed processing that does not require any hardware resources, a device having hardware resources is used for the purpose of providing only its CPU power. In this case, the hardware resources are not effectively used.

### SUMMARY OF THE INVENTION

According to the first aspect of the present invention, there is disclosed an information processing apparatus connected to a computer network, wherein when a print job is input and rendering processing based on the print job is executed by distributed processing using image processing devices connected to the computer network, the apparatus determines if hardware or software rendering processing is to be executed, searches the image processing devices connected to the computer network for those which can execute the hardware or software rendering processing, and transmits jobs divided from the print job to the image processing devices connected to the computer network on the basis of the determination and search results.

According to the second aspect of the present invention, there is disclosed an information processing apparatus connected to a computer network, wherein when a print job is input and rendering processing based on the print job is executed by distributed processing using image processing devices connected to the computer network, the apparatus determines if hardware or software rendering processing is to be executed, and when the determination result indicates the hardware rendering processing, the apparatus searches for image processing devices having hardware components of the same type and transmits jobs divided from the print job to the found image processing devices on the basis of the search result.

According to the aforementioned apparatus and processing, high-speed distributed processing can be implemented by effectively using hardware resources.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a diagram for explaining the architecture of grid computing;

FIG. 2 is a diagram for explaining the arrangement when the technique of desktop grid computing is applied to printer description language (PDL) processing;

FIG. 3 is a sectional view showing the structure of a printer according to an embodiment of the present invention;

FIG. 4 is a block diagram showing the arrangement of a printing system according to the embodiment of the present invention;

FIG. 5 is a chart illustrating an overview of processes of a printer driver;

FIG. 6 is a block diagram showing the hardware arrangement of a printer;

FIG. 7 is a chart for explaining the distributed processing of a printing system;

FIG. 8 is a diagram showing an example of distributed processing that implements hardware rendering processing;

FIG. 9 is a diagram showing an example of distributed processing that implements software rendering processing; and

FIG. 10 is a flowchart showing the processing of a DJS.

### DESCRIPTION OF THE PREFERRED EMBODIMENTS

Preferred embodiments of the present invention will be described in detail hereinafter with reference to the accompanying drawings.

### Grid Computing

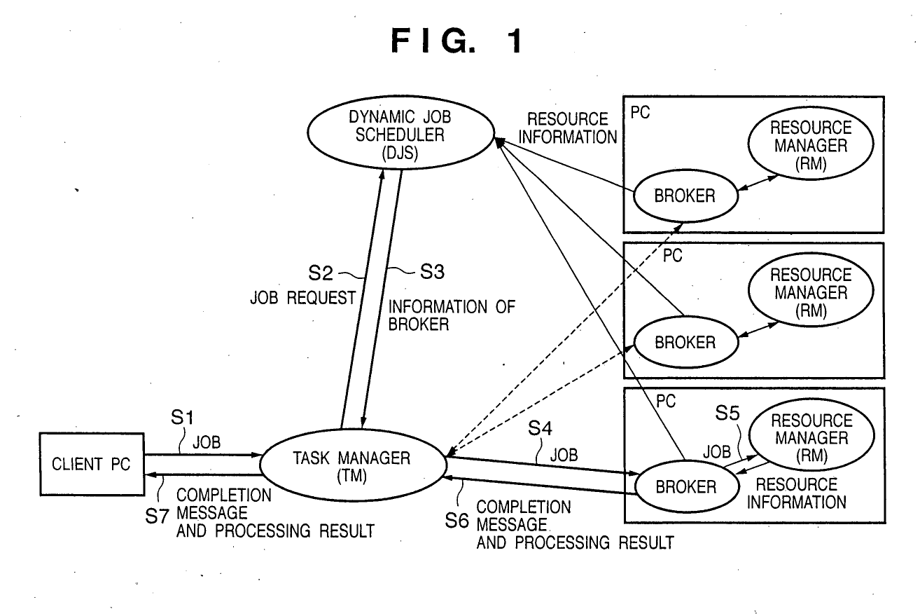

FIG. 1 is a diagram for explaining the architecture of grid computing. There are several types of grids. A grid to be described below is of the type called a desktop grid, which executes a job by utilizing an idle time of a CPU of a desktop PC or the like.

A client PC shown in FIG. 1 inputs a job in accordance with a user's instruction (S1). That request (job) is passed to a task manager (to be abbreviated as “TM” hereinafter), which informs a dynamic job scheduler (to be abbreviated as “DJS” hereinafter) of the contents (job request) (S2). The DJS which manages the resources of the overall grid computing system selects brokers of optimal resources and informs the TM of the selected brokers (S3). Note that the resource means an idle state of a CPU of a PC.

The broker in each PC registers, in the DJS, resource information which is received by a resource manager (to be abbreviated as “RM” hereinafter) in the PC. Upon reception of a request from the TM, the broker inputs a job to the RM (S4), and notifies the TM of completion of the job (and the processing result (S5). The TM inputs jobs to the brokers selected by the DJS, and monitors the status of these jobs. Upon reception of a completion message (and processing result) from each broker (S6), the TM sends a completion message (and processing result) to the client PC (S7).

The RM notifies the broker of the resource information, and inputs a job to the resource in accordance with a broker's instruction. The RM periodically checks the status of the resource. If the RM finds a change or abnormality of the resource (e.g., a trouble, reception of another job, or the like), it advises the broker accordingly.

With this scheme, the implementation form of desktop grid computing is to allow distributed processing by distributing jobs to the resources of optimal CPUs (which are not used normally).

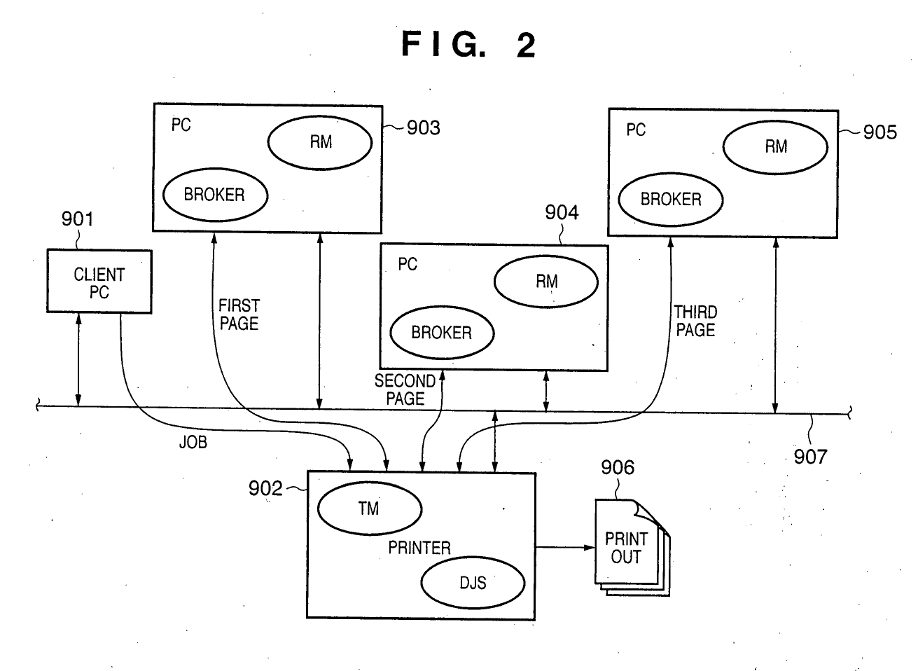

FIG. 2 is a diagram for explaining an example of the arrangement when the technique of desktop grid computing is applied to printer description language (PDL) processing. In the description of FIG. 1, modules which form the grid are handled as independent ones. However, when the technique of desktop grid computing is applied to a printer, a plurality of modules exist in a single device in general.

A client PC 901 in FIG. 2 issues a print instruction (inputs a print job) to a printer 902. The printer 902 has functions of the TM and DJS (i.e., it serves as a host machine of the distributed processing), and PCs 903 to 905 have functions of the broker and RM. This arrangement allows distributed processing based on grid computing using, e.g., three PCs connected to a network 907.

A job (print job of PDL format data) input from the client PC 901 is distributed to respective resources (e.g., the first page of that job to the PC 903, the second page to the PC 904, and the third page to the PC 905) by the TM and DJS of the printer 902 as the host machine, and these PCs execute rendering processes from the PDL data to image data. In this case, the printer 902 simultaneously transmits an application program for the rendering processing of PDL data to the respective resources. The printer 902 as the host machine collects images rendered based on the PDL data by the PCs (i.e., the processing results of images of the first to third pages), prints out images 906 for three pages, and notifies the client PC 901 of completion of the print job.

Of course, the target resources of this distributed processing may be four or more PCs, and the resource on the client PC 901 as a job input source may be used.

Also, printers and multi-functional peripheral equipments on the network can be used as target devices of the distributed processing. Upon roughly classifying these devices, a device which has high processing performance of a CPU implements rendering of PDL data, a process for converting rendered objects into bitmap data, and the like (to be collectively referred to as “rendering processing” hereinafter) when the CPU executes software. On the other hand, a device which has low processing performance of a CPU implements rendering processing by hardware. In the following description, the rendering processing by means of software will be referred to as “software rendering processing”, the software for rendering processing will be referred to as a “software rendering unit”, the rendering processing by means of hardware will be referred to as “hardware rendering processing”, and the hardware for rendering processing will be referred to as a “hardware rendering unit”.

Of course, whether the software or hardware rendering processing is to be executed is determined by various factors such as CPU performance, apparatus cost and size, and the like. Also, some processes of the rendering processing are often executed by hardware depending on the processing contents. Hence, the software or hardware rendering processing to be executed is not categorically determined by only the CPU processing performance. However, when a printer or multi-functional peripheral equipment is selected as a target device of the distributed processing, if that device has a hardware rendering unit, it is desired to perform processing distribution by effectively utilizing it.

An embodiment which implements higher-speed distributed processing by making processing distribution that considers hardware resources of devices when printers and multi-functional peripheral equipments are controlled to execute distributed processing by utilizing the technique of grid computing will be described in detail hereinafter.

### Printer

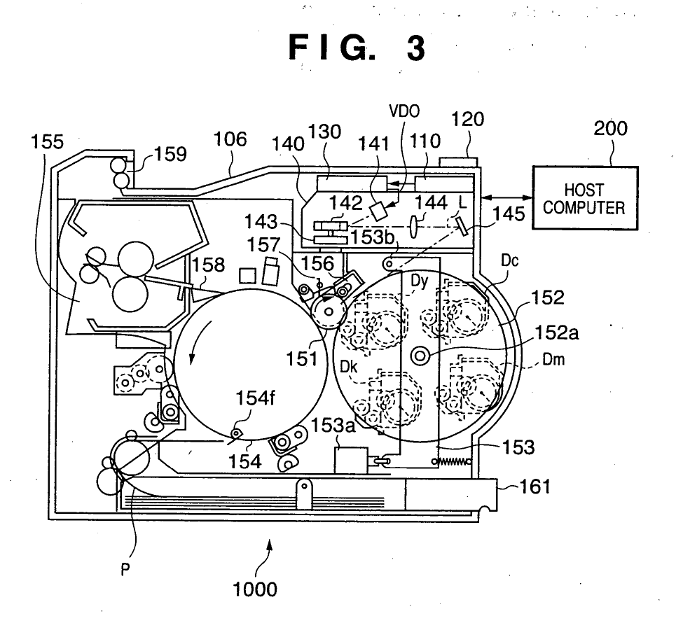

FIG. 3 shows the structure of a printer 1000 according to this embodiment. Note that this embodiment can be applied to a network environment to which a plurality of multi-functional peripheral equipments (MFPs), copying machines, and laser beam and ink-jet printers are connected. A color laser beam printer (to be simply referred to as a “printer” hereinafter) will be exemplified below as a typical printer. The printer 1000 shown in FIG. 3 prints an image at a recording density of 600 dpi on the basis of multi-valued data which expresses pixels of respective color components by 8-bit grayscale.

Referring to FIG. 3, the printer 1000 receives and stores a print command, which is supplied from an externally connected host computer 200, and includes print data (character codes, image data, PDL data, or the like) and a control code. The printer 1000 forms a character pattern, image, or the like in accordance with the received print command, and forms a color visible image on a print sheet. A formatter controller 110 interprets the print command supplied from the host computer 200 to generate a print image, and controls the overall printer 1000. The formatter controller 110 is connected to an operation panel 120 which receives a user's operation/instruction to inform the user of the status of the printer 1000. The operation panel 120 has switches, an LCD display, and the like, and is mounted as, e.g., a part of a housing of the printer 1000.

An output controller 130 reads out the final print image generated by the formatter controller 110 as a video signal VDO. The output controller 130 receives state signals from various sensors (not shown) arranged in respective units of the printer 1000, and outputs control signals to an optical unit 140 and various drive system mechanisms so as to control and execute print processing.

A print sheet P fed from a paper feed cassette 161 is held on the outer surface of a transfer drum 154 while its leading end is gripped by a gripper 154f. Electrostatic latent images of an image, which is color-separated into four colors, are formed on a photosensitive drum 151 in the order of yellow (Y), magenta (M), cyan (C), and black (Bk) by a laser beam output from the optical unit 140. The electrostatic latent image of each color is developed with toner by a corresponding developer Dy, Dm, Dc, or Dk in a developer selection mechanism 152. Toner images as the development results are overlaid and transferred onto the print sheet P on the transfer drum 154, thus forming a multi-color image on the print sheet P.

After that, the print sheet P is separated from the transfer drum 154, and is conveyed to a fixing unit 155. The print sheet P on which the toner images are fixed by heat and pressure by the fixing unit 155 is exhausted onto an exhaust tray 160 by an exhaust unit 159.

Note that the developers Dy, Dm, Dc, and Dk of respective colors have rotation support shafts at their two ends, and are held by the developer selection mechanism 152 to be rotatable about these shafts. With this mechanism, each developer can maintain its posture constant even when the developer selection mechanism 152 rotates about its rotation shaft 152a to select the developer, as shown in FIG. 3. After the selected developer moves to the developing position, a selection mechanism holding frame 153 having a fulcrum 153b is pulled by a solenoid 153a toward the photosensitive drum 151, and the developer selection mechanism 152 moves toward the photosensitive drum 151, thus performing the developing process.

The formatter controller 110 renders the print command to device-dependent bitmap data, and the output controller 130 reads out a video signal VDO corresponding to the bitmap data from the formatter controller 110. This video signal is input to a laser driver 141 to drive a semiconductor laser element. A laser beam L output from the semiconductor laser element is controlled to be turned on/off in accordance with the video signal VDO, and is reflected by a polygonal mirror 142, which is rotated at high speed by a scanner motor 143. The laser beam L then scans and exposes the surface of the photosensitive drum 151, which is uniformly charged to a predetermined polarity by a charger 156, via an f-θ lens 144 and reflecting mirror 145. As a result, an electrostatic latent image corresponding to the video signal VDO is formed on the photosensitive drum 151.

Next, an M electrostatic latent image is developed by the M developer Dm, and a first toner image of M is formed on the photosensitive drum 151. On the other hand, a print sheet P is fed from the paper feed cassette 161 at a predetermined timing. A transfer bias voltage having a polarity (e.g., plus polarity) opposite to toner is applied to the transfer drum 154 to electrostatically attract the print sheet P on the surface of the transfer drum 154, and the first toner image on the photosensitive drum 151 is transferred onto the print sheet P. After the toner image is transferred, residual toner on the photosensitive drum 151 is removed by a cleaner 157 to prepare for latent image formation and development of the next color.

In the same sequence, scan exposure of electrostatic latent images of the second, third, and fourth colors, and development and transfer of toner images are done in the order of C, Y, and Bk. Upon transferring the second, third, and fourth colors, a bias voltage higher than the previous formation is applied to the transfer drum 154.

When the leading end of the print sheet P on which the toner images of four colors have been overlaid and transferred approaches the separation position, a separation pawl 158 comes closer, and its leading end contacts the surface of the transfer drum 154 to separate the print sheet P from the transfer drum 154. The separated print sheet P is conveyed to the fixing unit 155 to fix the toner images on the print sheet, and is then exhausted onto the exhaust tray 160.

The printer 1000 outputs an image at a resolution of 600 dpi via the aforementioned image formation process. Note that a printer which can be used as that of this embodiment is not limited to the color laser beam printer. Alternatively, color printers of other schemes such as an ink-jet printer, thermal printer, and the like may be used, or a monochrome printer may be used.

### Printing System

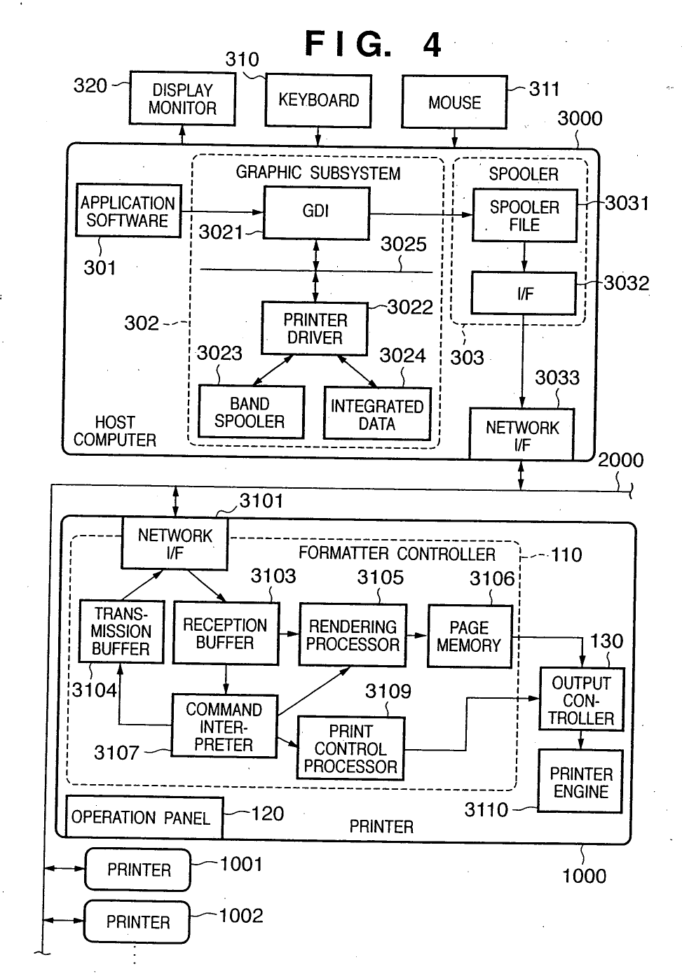

FIG. 4 is a block diagram showing the arrangement of the printing system of this embodiment. The printing system has an arrangement in which a host computer 3000 and a plurality of printers 1000, 1001, 1002, . . . are connected to each other via a communication path 2000. Note that FIG. 4 illustrates three printers, but the number of printers is not limited.

Formatter Controller

The formatter controller 110 is also called a PDL controller or the like, and comprises a network interface (I/F) 3101 for making communications with the host computer 3000 or the like, a reception buffer 3103 for temporarily holding reception data and the like, a transmission buffer 3104 for temporarily holding transmission data and the like, a command interpreter 3107 for interpreting print data, a print control processor 3109 for executing print control processing, a rendering processor 3105 for executing rendering processing, a page memory 3106, and the like.

The network I/F 3101 exchanges print data with the host computer 3000 or the like. An arbitrary connection method between the host computer 3000 and printer may be adopted. For example, a connection via a computer network such as a Local area network (LAN) or the like, or a connection via a serial bus such as USB (Universal Serial Bus), IEEE1394, or the like may be used. Of course, infrared rays or radio may be used as the communication path 2000.

Print data received by the network I/F 3101 is sequentially stored in the reception buffer 3103, and is read out and processed by the command interpreter 3107 or rendering processor 3105 as needed. The command interpreter 3107 is implemented by a control program according to a print command system and print job control language. When a command pertains to text printing or rendering of a graphic, image, or the like, the command interpreter 3107 issues its processing instruction to the rendering processor 3105; when a command pertains to processing other than rendering and is a paper select command, reset command, or the like, it issues its processing instruction to the print control processor 3109.

The rendering processor 3105 is a YMCK rendering unit which sequentially renders respective rendering objects of characters and images on a band memory in the page memory 3106. In case of the color laser beam printer shown in FIG. 3, device-dependent bitmap data must be sent to a printer engine 3110 in the order of M, C, Y, and K. However, the memory capacity required for all these data is not always assured in a default state. That is, the rendering processor 3105 assures a memory area with a size of a fraction of one plane (1, 2, or 4 bits/pixel) as a band memory, and executes the rendering processing synchronized with the processing of the printer engine 3110 by repetitively using the band memory. Note that the printer engine 3110 is a generic name of the overall arrangement which includes the optical unit 140, photosensitive drum 151, developer selection mechanism 152, transfer drum 154, fixing unit 155, and the like shown in FIG. 3, and executes the aforementioned image formation process.

Normally, the page memory 3106 is managed by banding control in which shipping processing of a video signal to the printer engine 3110 pursues the rendering processing of the rendering processor 3105. However, if a sufficient memory capacity is available, a memory area on which bitmap data for one page can be mapped may be assured.

In general, the formatter controller 110 is implemented when a computer system that uses a central processing unit (CPU), read-only memory (ROM), random-access memory (RAM), and the like executes a control/processing program for a formatter controller. Processes of respective units in the formatter controller 110 may be processed by time sharing on the basis of a multi-task monitor (realtime OS), or dedicated controller hardware components may be prepared for respective functions to independently execute these processes.

When the printer has a hardware rendering unit, the CPU (or that of the printer 1000) of the formatter controller 110 controls, in accordance with the processing contents and its hardware rendering unit, to select whether the rendering processor 3105 executes some or all processes of the rendering processing (software rendering processing) or the hardware rendering processing is executed.

The operation panel 120 receives user's operations/instructions and notifies the user of the status of the printer 1000, as described above. An output controller 3108 converts bitmap data mapped on the band memory (page memory) 3106 into a video signal, and transfers the video signal to the printer engine 3110. The printer engine 3110 forms a visible image on a print sheet on the basis of the received video signal.

Host Computer

The host computer 3000 outputs print data including print data and a control code to the printer 1000. The host computer 3000 is configured as one computer system to which a keyboard 310 and mouse 311 as input devices, and a display monitor 320 as a display device are connected. Note that the host computer 3000 is controlled by basic software (OS) such as Windows® or the like on the basis of hardware components such as a central processing unit (CPU), read-only memory (ROM), random-access memory (RAM), hard disk drive (HDD), various input/output controllers (I/Os), and the like, and respective application software programs and subsystem processes serve as function modules on the basis of that basic software.

Paying attention to only functions that pertain to this embodiment, the function modules of the host computer 3000 are classified into application software 301, a graphic subsystem 302, spooler 303, and network interface 3033 which communicates with the printer. The application software 301 is general application software such as a word processor, spreadsheet, or the like, which runs on the OS and creates documents.

The graphic subsystem 302 comprises a Graphic Device Interface (to be abbreviated as “GDI” hereinafter) 3021 as a part of the functions of the OS, a printer driver 3022 as a device driver which is dynamically linked from the GDI 3021, and a band spooler 3023 and integrated data 3024 (both of which are stored on a predetermined area of the RAM). The printer driver 3022 is called from the GDI 3021 via a Device Driver Interface (to be abbreviated as “DDI” hereinafter) 3025, and executes processing depending on the printer for respective rendering objects. The host computer 3000 according to this embodiment includes two different types of processing. In one process, information passed to the DDI function is converted into a print command data (PDL) format that can be processed by the printer at high speed, and the converted data is directly output to the spooler 303. In the other process, generated print command data is divided into bands and is held on the band spooler 3023 for one page in turn from the first band, and the held band data are output to the spooler 303 together at the end of the page.

The spooler 303 is a spool file system managed by the OS. The spooler 303 stores print data for one page or job depending on settings as a spool file 3031 (its storage area is assigned to the HDD), and transmits the spool file to the printer via an I/F 3032 and the network I/F 3033.

The names of the aforementioned units and functional framework may be slightly different depending on the OS, but such differences of these names and framework do not influence the gist of this embodiment. For example, a module called a spooler or spool file in this embodiment can be implemented using a module called a print queue in another OS.

Processing of Printer Driver

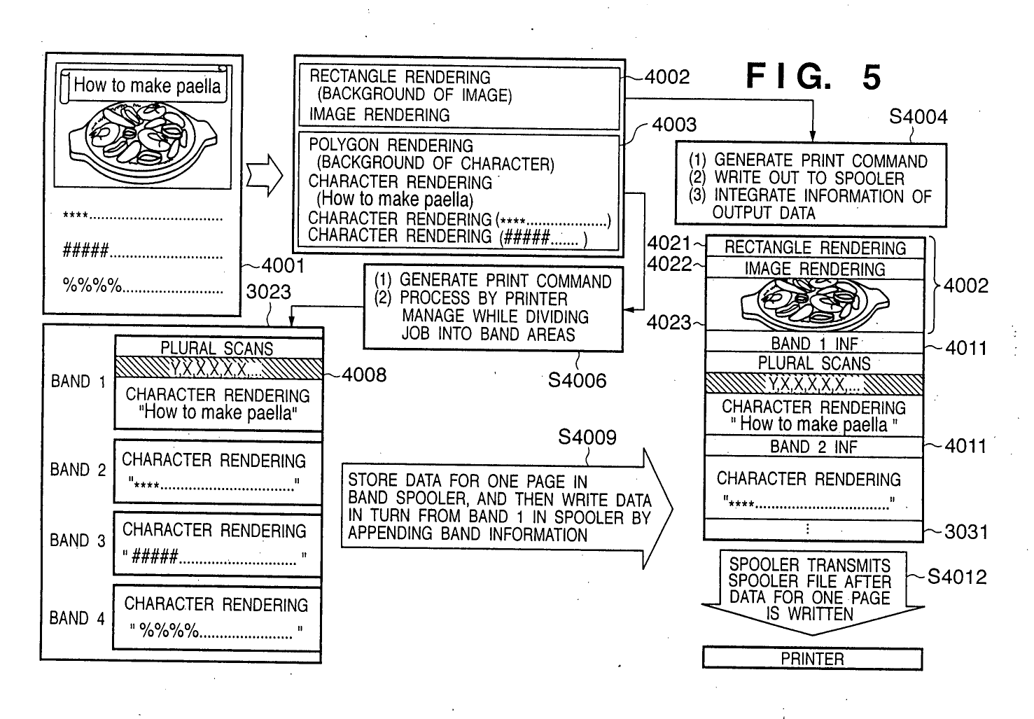

FIG. 5 shows an overview of the processing of the printer driver 3022. Assume that a document 4001 created using a general document creation application includes graphics, text, and image data.

Upon printing the document 4001, rendering commands 4002 and 4003 are passed to the printer driver 3022 installed in the OS via the OS. In a default state, the printer driver 3022 generates print commands (PDL data) for respective rendering commands as in a normal PDL mode-based driver, writes them in the spooler 303, and integrates the data sizes calculated by a predetermined calculation formula in accordance with the number and types of commands as integrated data 3024 (S4004). Note that the rendering commands (DDI functions) received by the printer driver 3022 via the OS are output in turn from lower layers of a stack of rendering objects. When all data for one page are written, the spooler 303 transmits the print commands (PDL data) stored as the spool file 3031 and the integrated data 3024 to the task manager, clears the spool file 3031, and instructs the printer driver 3023 to clear the integrated data 3024 (step S4012).

On the other hand, when the value of the integrated data 3024 exceeds a predetermined data size, the number of commands, or the like, the processing for each page is switched to that for respective bands, which will be described below. Assume that rendering objects up to “rectangle rendering (background of image)” 4021, “image rendering” 4022, and “entity of image (image data)” 4023 shown in FIG. 5 are stored in the spooler 303, and the processing for each page is switched to that for respective bands at the timing when the integrated data 3024 exceeds a threshold of the predetermined data size when the “entity of image” 4023 is output to the spooler 303.

Upon switching to the processing for respective bands at the above timing, the printer driver 3022 generates print commands for rendering commands 4003 after the “entity of image” 4023, and separately stores and manages the print commands in the band spooler 3023 in the rendering order for respective band areas to be processed by the printer (S4006). Since the rendering commands 4003 (DDI functions) passed from the OS are output irrespective of the print direction of the printer, even when the processing for respective bands is switched from the middle of a page, storage processing for all bands (first to N-th bands) in the page is done.

The storage processing is executed every time the DDI function in the printer driver 3022 is called. If the storage area assured for the processing for respective bands becomes full of data, a new area is assured on the RAM. Upon completion of storage of rendering data from the first to N-th bands, which correspond to the remaining data of one page, data are written out onto the spooler 3003 in the order of bands to be processed by the printer, and the band spooler 3023 is cleared (S4009).

Information (Band N inf) 4011 of next band data to be output is appended to the head of each band data, thus making the printer recognize that the print data is switched from the page unit to the band unit. When print data for one page is written, the spooler 303 transmits the spool file 3031 and integrated data 3024 to a task manager (to be described later), clears the spool file 3031, and instructs the printer driver 3022 to clear the integrated data 3024 (S4012).

Hardware Arrangement of Printer

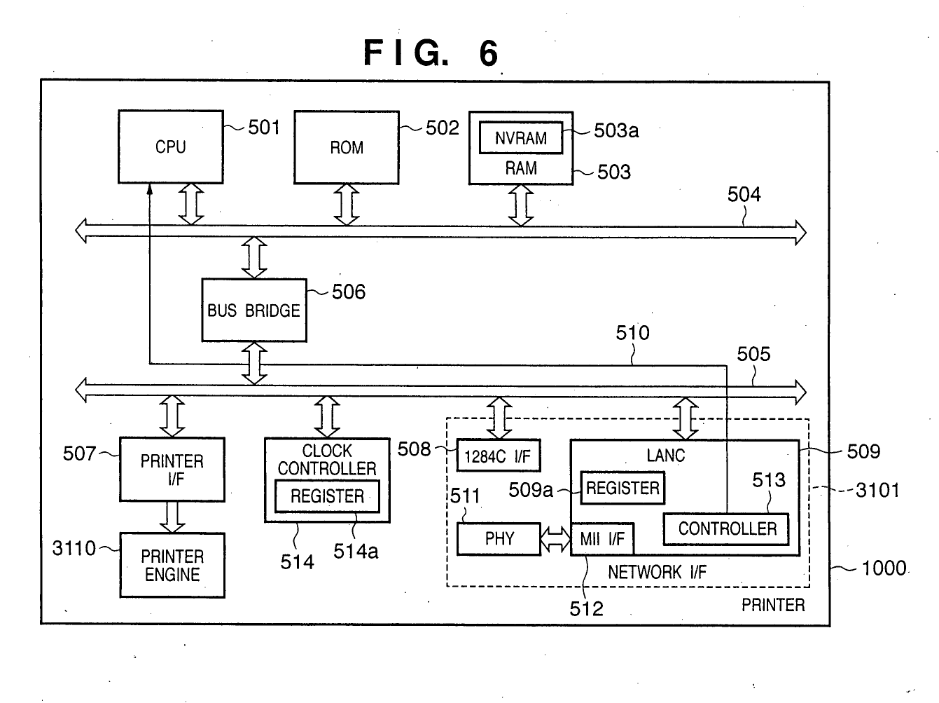

FIG. 6 is a block diagram showing the hardware arrangement of a printer.

A CPU 501 of the printer executes control of the overall printer, arithmetic processing including an image process, and the like in accordance with control/processing programs stored in a ROM 502 using a RAM 503 as a work memory. The ROM 502 stores the control/processing programs and the like, and the CPU 501 operates by reading out and executing the programs from the ROM 502. The RAM 503 is used as the reception buffer 3103 and transmission buffer 3104 for temporarily storing reception/transmission data with the network 2000, the page memory 3106 for temporarily storing rendered image data, a work memory for temporarily saving data required for arithmetic operations of the CPU 501, and the like. By combining these CPU 501, ROM 502, and RAM 503, the formatter controller 110 and the like are implemented.

The CPU 501, ROM 502, and RAM 503 are connected to each other via a system bus 504, and are also connected to an extended bus 505 via a bus bridge 506. The system bus 504 and extended bus 505 are independently operable due to the presence of the bus bridge 506. A printer I/F 507 transfers image data stored in the RAM 503 and the like to the printer engine 3110.

The network I/F 3101 comprises an IEEE1284 I/F 508 as a Bicentronics interface, and a LANC 509. A PHY 511 is a physical transceiver used to connect the network 2000. An MII I/F 512 is an interface used to connect the LANC 509 to the PHY 511, and makes handshake data transfer with the PHY 511. An internal controller 513 of the LANC 509 performs control in the LANC 509 and control of external communications. The controller 513 can send an interrupt to the CPU 501 via a dedicated signal line 510, and can notify the CPU 501 of end of data transmission/reception with the network 2000. When a data packet is received from another device on the network 2000 and a specific bit pattern is detected from that data packet (to be referred to as “reception of a specific packet” hereinafter), the controller 513 sends to the CPU 501 an interrupt that advises accordingly. Note that the specific packet includes a magic packet® and a packet indicating start of distributed processing to be described later, and the bit patterns of these packets are held in advance in the controller 513. Note that the bit pattern of the packet indicating start of distributed processing is set in advance between the host computer and printer. In this embodiment, the packet which has the specific bit pattern indicating start of distributed processing is called a “Grid packet”.

A clock controller 514 distributes clocks to the respective modules via a clock supply line (not shown). The clock controller 514 can make the following control operations in accordance with the value of a register 514a which can be set by the CPU 501: stop of clocks to be supplied to some modules (to be referred to as “clock stop” hereinafter), cancel of clock stop, setting of clocks to be supplied to some modules lower than a normal operation state (to be referred to as “clock down” hereinafter), restoration of clocks to the frequency of the normal operation (to be referred to as “clock up” hereinafter), and the like.

Distributed Processing

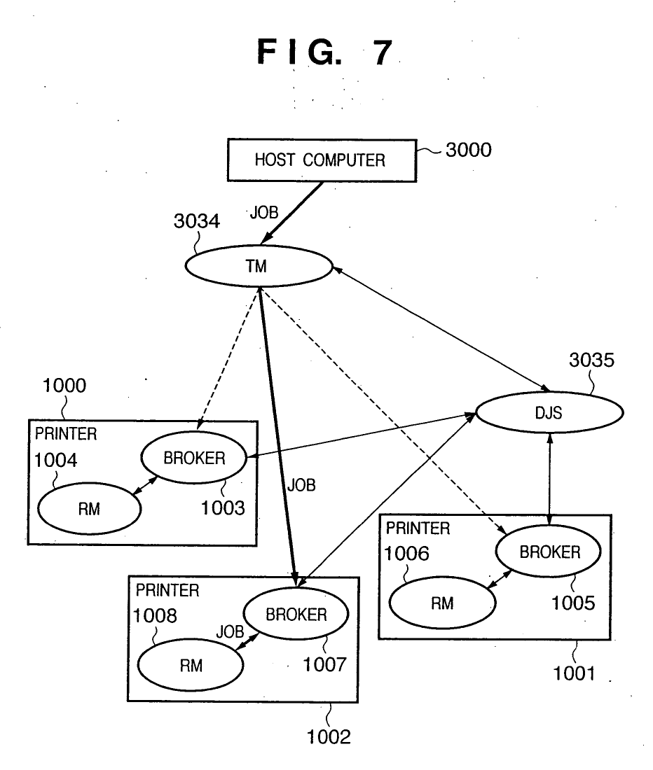

FIG. 7 is a chart for explaining the distributed processing of the printing system. In the following description, a task manager (TM) 3034 and dynamic job scheduler (DJS) 3035 are implemented by software installed on basic software which is executed by the CPU of the host computer 3000. Also, a broker and resource manager (RM) are implemented by software installed on basic software which is executed by the CPU of each printer.

The host computer 3000 starts a job. In other words, a user inputs an instruction for instructing execution of a printing for the job to a printer through the printer driver of the host computer 3000. In this embodiment, the job means a print operation. Upon reception of the job, the TM 3034 sends a job request to the DJS 3035 so as to request it to interpret the job. Based on the interpretation result (including a message indicating an optimal broker or brokers) from the DJS 3035, the TM 3034 inputs the job to brokers 1003, 1005, and/or 1007 (FIG. 7 shows a state wherein the job is input to the broker 1007 of the printer 1002). Note that the DJS 3035 periodically inquires the status of each broker to keep track of the situation of the resource (for example, idle state of the printer, or idle state of a hardware rendering unit or software rendering unit) and that of the entire printing system, thus selecting an optimal broker or brokers.

The brokers 1003, 1005, and 1007 of the printers receive the idle states of the resources and the like from their RMs 1004, 1006, and 1008, and register them in the DJS 3035. When the TM 3034 inputs a job to each broker, the broker searches for an optimal resource, inputs the job to that resource via the RM, and sends a job completion message (and processing result) from the RM to the TM 3034. If the resource suffers any abnormality, each RM advises the broker of the same printer accordingly. Note that the abnormality includes a case wherein a job is input from another client, and a job to be input or the input job from the TM 3034 cannot be continuously processed.

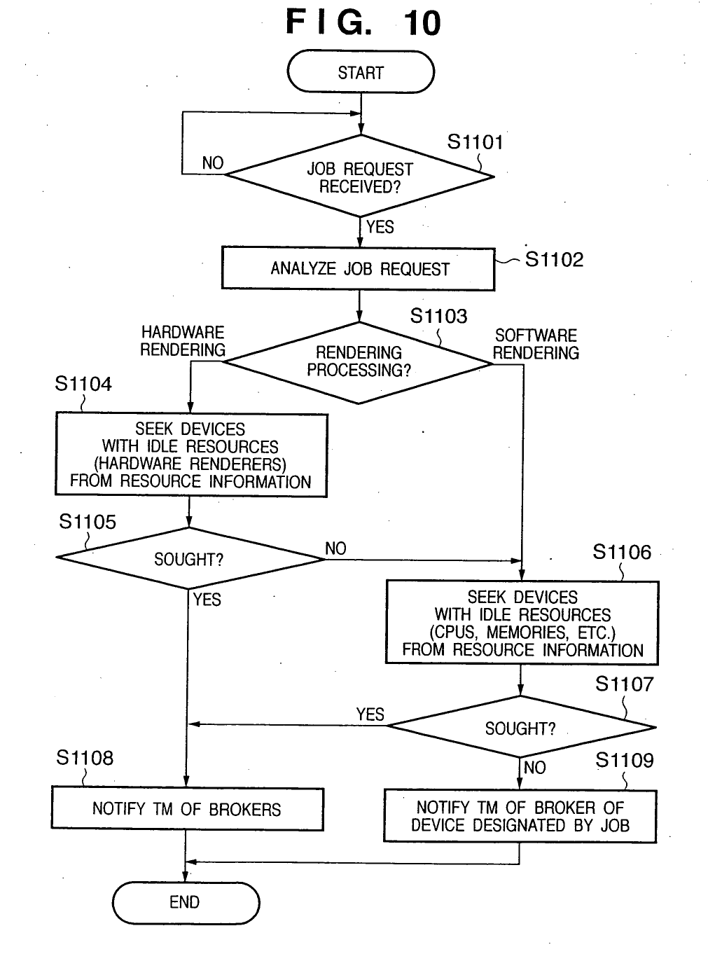

The results of the distributed processing, which are obtained by a processing of the DJS 3035 shown in FIG. 10, are integrated in the printer designated by the user. The printer prints the job input by the user in accordance with the integrated results of the distributed processing. Therefore, the printing considering the situation of the resources can be efficiently executed. Especially, as for detail is mentioned later, high-speed processing, which effectively uses hardware resources having the same specification, can be executed.

### Distributed Processing of Rendering Processing

As described above, in some cases, some processes of the rendering processing undergo the hardware rendering processing, and other processes undergo the software rendering processing by the rendering processor 3105 depending on the processing contents. In order to realize speeding up due to the distributed processing when some or all processes of the rendering processing undergo the hardware rendering processing, the processing results of hardware rendering units equipped in target devices of the distributed processing cannot be simply integrated unless these hardware rendering units have identical output specifications. Note that the output specification includes the number of bits in the rendering processing, a color space in the rendering processing, a generation of the hardware rendering unit, and the like. For this reason, data correction and the like are required upon integrating the output results. As a result, the work efficiency drops, and speeding up cannot often be achieved.

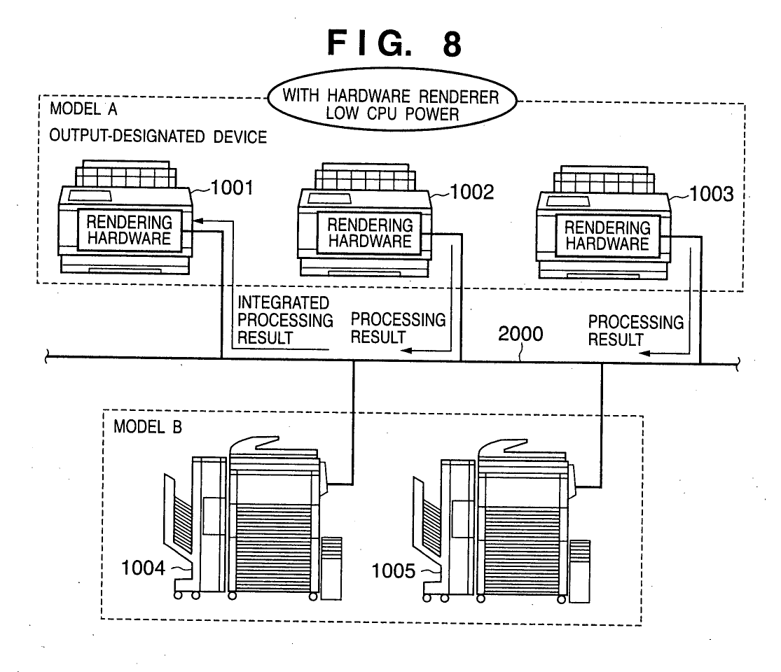

FIG. 8 is a diagram showing an example of the distributed processing that implements the hardware rendering processing in the printing system with the scheme shown in FIG. 7.

Referring to FIG. 8, a printer 1001 is a device which is designated to print out data by a job. Also, printers 1002 and 1003 (to be referred to as “model A” hereinafter) which are of the same model as the printer 1001, i.e., mount the same hardware as the printer 1001 are connected onto the network 2000. Therefore, in order to implement the high-speed distributed processing by the hardware rendering processing so as not to disturb speeding up owing to the aforementioned reasons, the TM 3034 inputs divided processes for respective bands or pages by selecting the printer 1001 and the printers 1002 and 1003 having the same hardware as the printer 1001 as distributed target devices, and controls them to execute hardware rendering processing. The TM 3034 then integrates their rendering processing results and inputs the integrated result to the printer 1001, thus controlling the printer 1001 to execute print processing.

On the other hand, each broker of model A can transmit, to the DJS 3035, resource information of a hardware rendering unit as that of distributed processing on the basis of the resource information received from the RM, but does not transmit resource information of the CPU 501 (does not register the CPU 501 as a software resource). When such resource information is registered, the TM 3034 recognizes the hardware rendering unit of model A as a resource for the distributed processing, and never recognizes the CPU 501 as a software resource for the distributed processing. Therefore, the CPU 501 of model A with low processing performance can dedicate itself to control and processing of the self machine without being used in the distributed processing. If a printer having a hardware rendering unit different from the hardware rendering unit of the printer 1001 is connected to the network 2000, the broker of model A recognizes resource information of the printer having the different hardware rendering unit, and does not transmit the resource information to the DJS 3035. Thus the printer having the different hardware rendering unit is not used in the distributed processing because the resource information of that printer is not registered.

Since the distributed processing by the software rendering processing does not depend on the output specifications of the hardware rendering units unlike the distributed processing by the hardware rendering processing, distributed processing using a combination of different models can be made (permitted).

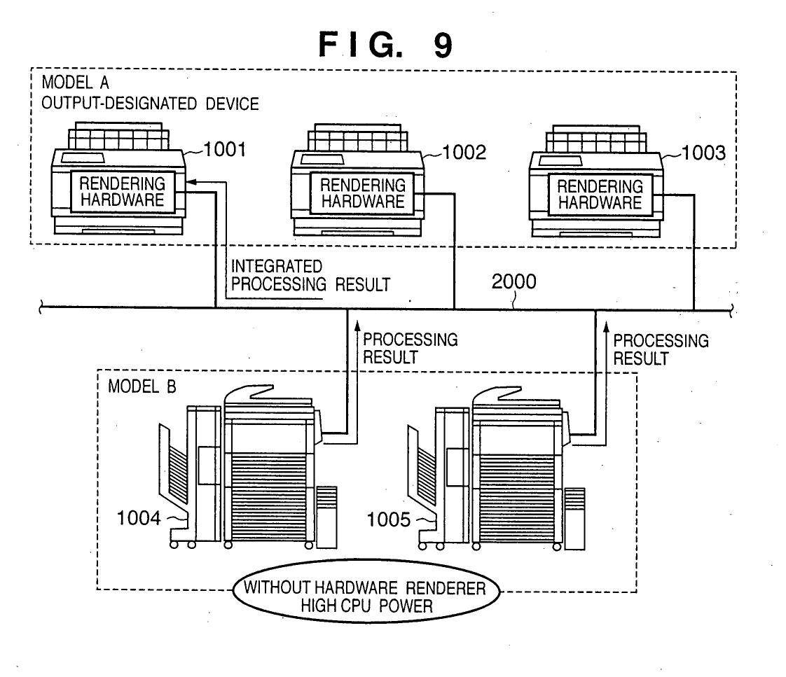

FIG. 9 is a diagram showing an example of the distributed processing that implements the software rendering processing, i.e., the distributed processing that implements rendering processing when no idle hardware rendering units (resources) are found or when speeding up by the hardware rendering processing cannot be expected.

Referring to FIG. 9, a printer 1001 is a device which is designated to print out data by a job. Printers 1004 and 1005 (to be referred to as “model B” hereinafter) do not have any hardware rendering unit, but execute software rendering processing by their high-speed CPUs. Therefore, the TM 3034 inputs divided processes for respective bands or pages to the printers 1004 and 1005 and the printout-designated printer 1001 and controls them to execute software rendering processing. Then, the TM 3034 integrates their rendering processing results, and inputs the integrated result to the printer 1001, thus controlling the printer 1001 execute print processing.

As for some rendering processes for which speeding up cannot be expected by the hardware rendering processing of model A, distributed processing which uses software rendering processing of model B together is available.

Whether the hardware or software rendering processing is executed is determined on the basis of broker messages returned from the DJS 3035 that receives a job request. Hence, resource information to be provided from the printer of model A or B to the DJS 3035 includes information indicating a device having a hardware rendering unit, information required to select devices with hardware rendering units of the same output specifications, information indicating devices that can implement software rendering unit s by high-speed CPUs, and the like.

FIG. 10 is a flowchart showing the processing of the DJS 3035.

The DJS 3035 waits for reception of a job request (S1101). Upon reception of a job request, the DJS 3035 interprets the received job request (S1102), and determines, based on the interpretation result, whether the hardware or software rendering processing is executed, or whether or not some processes of the rendering processing are implemented by software rendering processing (S1103). If the determination result indicates the hardware rendering processing, the DJS 3035 searches for devices with idle resources (hardware rendering units) based on the resource information (S1104). If such devices are found (S1105), the DJS 3035 notifies the TM 3034 of the search result as a broker message (S1108).

If the determination result indicates the software rendering processing, or if no devices with idle resources (hardware rendering unit s) are found, the DJS 3035 searches for devices with idle resources (CPUs, memories, and the like) based on the resource information (S1106). If such devices are found (S1107), the DJS 3035 notifies the TM 3034 of the search result as a broker message (S1108).

If no devices with idle resources (CPUs, memories, and the like) are found, the DJS 3035 determines that it is impossible to execute the distributed processing, and notifies the TM 3034 of a broker of a device designated by the job (S1109).

Note that the TM 3034 may make the above determination with reference to the resource information registered in the DJS 3035 and may select target devices (brokers) of the distributed processing.

As described above, when speeding up of the distributed processing by the hardware rendering processing is expected, if the distributed processing is executed using devices which mount hardware rendering units of the same type, consistency of the hardware rendering processing results can be maintained. Therefore, high-speed distributed processing that fully utilizes the performance of the hardware rendering units can be implemented. On the other hand, when no idle hardware rendering units (resources) are found or when speeding up by the hardware rendering processing cannot be expected, software rendering processing can be used. Therefore, high-speed distributed processing can be implemented, and the entire printing system can be efficiently managed.

The resource is not limited to the rendering unit for the rendering processing though the rendering unit is explained as a sample of the resource in the above. For example, a hardware of software module for image processing different from the rendering processing is included in the resource too. Therefore, the above processing for the distributed processing can be applied to the above hardware or software module.

Other Embodiment

The present invention can be applied to a system constituted by a plurality of devices (e.g., host computer, interface, reader, printer) or to an apparatus comprising a single device (e.g., copying machine, facsimile machine).

Further, the object of the present invention can also be achieved by providing a storage medium storing program codes for performing the aforesaid processes to a computer system or apparatus (e.g., a personal computer), reading the program codes, by a CPU or MPU of the computer system or apparatus, from the storage medium, then executing the program.

In this case, the program codes read from the storage medium realize the functions according to the embodiments, and the storage medium storing the program codes constitutes the invention.

Further, the storage medium, such as a flexible disk, a hard disk, an optical disk, a magneto-optical disk, CD-ROM, CD-R, a magnetic tape, a non-volatile type memory card, and ROM can be used for providing the program codes.

Furthermore, besides aforesaid functions according to the above embodiments are realized by executing the program codes which are read by a computer, the present invention includes a case where an OS (operating system) or the like working on the computer performs a part or entire processes in accordance with designations of the program codes and realizes functions according to the above embodiments.

Furthermore, the present invention also includes a case where, after the program codes read from the storage medium are written in a function expansion card which is inserted into the computer or in a memory provided in a function expansion unit which is connected to the computer, CPU or the like contained in the function expansion card or unit performs a part or entire process in accordance with designations of the program codes and realizes functions of the above embodiments.

In a case where the present invention is applied to the aforesaid storage medium, the storage medium stores program codes corresponding to the flowcharts described in the embodiments.

As many apparently widely different embodiments of the present invention can be made without departing from the spirit and scope thereof, it is to be understood that the invention is not limited to the specific embodiments thereof except as defined in the claims.

### CLAIM OF PRIORITY

This application claims priority from Japanese Patent Application No. 2004-171766, filed on Jun. 9, 2004, which is hereby incorporated by reference herein.

1. An information processing apparatus connected to a computer network, comprising:
an input section, arranged to input a print job;
a determiner, arranged to determine, when rendering processing of the print job undergoes distributed processing by image processing devices connected to the computer network, whether hardware or software rendering processing is to be executed;
a seeker, arranged to seek image processing devices which can implement the hardware or software rendering processing from the image processing devices connected to the computer network; and
a controller, arranged to transmit jobs divided from the print job to the image processing devices connected to the computer network on the basis of the determination and seek results.

2. The apparatus according to claim 1, wherein when the determination result indicates the hardware rendering processing, and image processing devices that can implement the hardware rendering processing are found, said controller transmits the divided jobs to the image processing devices.

3. The apparatus according to claim 1, wherein when the determination result indicates the software rendering processing, and image processing devices that can implement the software rendering processing are found, said controller transmits the divided jobs to the image processing devices.

4. The apparatus according to claim 1, wherein when the determination result indicates the hardware rendering processing, first image processing devices that can implement the hardware rendering processing are not found, and second image processing devices that can implement the software rendering processing are found, said controller transmits the divided jobs to the second image processing devices.

5. The apparatus according to claim 1, wherein when no image processing devices for the distributed processing are found, said controller transmits the job to an image processing device designated by the job.

6. The apparatus according to claim 1, further comprising:
a receiver, arranged to receive processing results of the divided jobs;
an integrator, arranged to integrate the processing results of the divided jobs; and
a transmitter, arranged to transmit the integrated result of said integrator as print data to an image processing device designated by the print job.

7. A method of controlling an information processing apparatus connected to a computer network, the method comprising the steps of:
inputting a print job;
determining, when rendering processing of the print job undergoes distributed processing by image processing devices connected to the computer network, whether hardware or software rendering processing is to be executed;
seeking image processing devices which can implement the hardware or software rendering processing from the image processing devices connected to the computer network; and
transmitting jobs divided from the print job to the image processing devices connected to the computer network on the basis of the determination and seek results.

8. An information processing apparatus connected to a computer network, comprising:
an input section, arranged to input a print job;
a determiner, arranged to determine, when rendering processing of the print job undergoes distributed processing by image processing devices connected to the computer network, whether hardware or software rendering processing is to be executed;
a seeker, arranged to seek, when said determiner determines that the hardware rendering processing is to be executed, image processing devices of an identical model; and
a controller, arranged to transmit jobs divided from the print job to found image processing devices on the basis of the seek result.

9. The apparatus according to claim 8, wherein when said determiner determines that the software rendering processing is to be executed, said seeker permits distributed processing using image processing devices of different models.

10. The apparatus according to claim 8, wherein said seeker does not select an image processing device which is not registered as a software resource in a dynamic job scheduler as an image processing device that implements the software rendering processing.

11. A method of controlling an information processing apparatus connected to a computer network, the method comprising the steps of:
inputting a print job;
determining, when rendering processing of the print job undergoes distributed processing by image processing devices connected to the computer network, whether hardware or software rendering processing is to be executed;
seeking, when the determination result indicates the hardware rendering processing, image processing devices of an identical model; and
transmitting jobs divided from the print job to found image processing devices on the basis of the seek result.

12. A computer program for a method of controlling an information processing apparatus connected to a computer network, the method comprising the steps of:
inputting a print job;
determining, when rendering processing of the print job undergoes distributed processing by image processing devices connected to the computer network, whether hardware or software rendering processing is to be executed;
seeking image processing devices which can implement the hardware or software rendering processing from the image processing devices connected to the computer network; and
transmitting jobs divided from the print job to the image processing devices connected to the computer network on the basis of the determination and seek results.

13. A computer program for a method of controlling an information processing apparatus connected to a computer network, the method comprising the steps of:
inputting a print job;
determining, when rendering processing of the print job undergoes distributed processing by image processing devices connected to the computer network, whether hardware or software rendering processing is to be executed;
seeking, when the determination result indicates the hardware rendering processing, image processing devices of an identical model; and
transmitting jobs divided from the print job to found image processing devices on the basis of the seek result.

14. A computer program product stored on a computer readable medium, the program comprising computer program code for a method of controlling an information processing apparatus connected to a computer network, the method comprising the steps of:
inputting a print job;
determining, when rendering processing of the print job undergoes distributed processing by image processing devices connected to the computer network, whether hardware or software rendering processing is to be executed;
seeking image processing devices which can implement the hardware or software rendering processing from the image processing devices connected to the computer network; and
transmitting jobs divided from the print job to the image processing devices connected to the computer network on the basis of the determination and seek results.

15. A computer program product stored on a computer readable medium, the program comprising computer program code for a method of controlling an information processing apparatus connected to a computer network, the method comprising the steps of:
inputting a print job;
determining, when rendering processing of the print job undergoes distributed processing by image processing devices connected to the computer network, whether hardware or software rendering processing is to be executed;
seeking, when the determination result indicates the hardware rendering processing, image processing devices of an identical model; and
transmitting jobs divided from the print job to found image processing devices on the basis of the seek result.

16. An image processing method, comprising the steps of:
receiving an instruction to process a print job to be printed by a predetermined printer;
determining devices, which have the same specification, from image processing devices;
transmitting jobs divided from the print job to the devices based on the determination; and
printing the divided jobs, which were processed by the devices, by the predetermined printer.
